(19) United States
(12) Patent Application Publication
(10) Pub. No.: US 2019/0067719 A1
(43) Pub. Date: Feb. 28, 2019

(54) METHOD FOR MANUFACTRING AN OVERMOLDED UNITIZED ELECTRODE ASSEMBLY

(71) Applicant: GM GLOBAL TECHNOLOGY OPERATIONS LLC, DETROIT, MI (US)

(72) Inventor: Jeffrey A. Rock, Rochester Hills, MI (US)

(21) Appl. No.: 15/682,960

(22) Filed: Aug. 22, 2017

(51) Int. Cl. H01M 8/1004; H01M 8/1018; B29C 45/14

(52) U.S. Cl. CPC H01M 8/1004; H01M 8/1018; B29C 45/14311; B29L 2031/3468; H01M 2008/1095; H01M 2300/0082; B29C 2045/14327; B29C 45/14336

(57) ABSTRACT

A process for manufacturing a stepped UEA includes the steps of providing a major diffusion layer, a PEM layer and a minor diffusion layer onto a lower supporting mold; enclosing the major diffusion layer, a PEM layer and a minor diffusion layer in the lower supporting mold and the upper mold; injecting a polymeric material into the mold; permeating the polymeric material into a peripheral edge area of each of the major and minor diffusion layers and molding the polymeric material directly onto the peripheral edge area of the PEM; and removing the overmolded UEA from the upper mold and lower supporting mold.

### TECHNICAL FIELD

The present disclosure relates to a fuel cell assembly, and in particular, a method for manufacturing a robust unitized electrode assembly arrangement with an overmolded subgasket.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”), to provide ion transport between the anode and cathode.

Fuel cells in general are an electrochemical device that converts the chemical energy of a fuel (hydrogen, methanol, etc.) and an oxidant (air or pure oxygen) in the presence of a catalyst into electricity, heat and water. Fuel cells produce clean energy throughout the electrochemical conversion of the fuel. Therefore, they are environmentally friendly because of the zero or very low emissions. Moreover, fuel cells are high power generating system from a few watts to hundreds of kilowatts with efficiencies much higher than a conventional internal combustion engine. Fuel cells also have low noise production because of few moving parts.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ionically conductive polymer membrane to the cathode where they combine with oxygen to form water, which is discharged from the cell. The proton exchange membrane is sandwiched between a pair of porous gas diffusion layers (“GDL”), which in turn are sandwiched between a pair of non-porous, electrically conductive elements or plates (i.e., flow field plates). The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

As shown in FIGS. 2A-2B, seals may be integrated in a traditional unitized electrode assembly 110 by integrating the straight edge 167 of the UEA with the subgasket 134 by impregnating the porous electrode layers 122, 120 on either side of the proton exchange membrane 124 as shown in FIG. 1. The subgasket 134 may extend laterally beyond the uniform or straight edge 167 of the UEA 110 and envelopes its periphery. However, in light of the viscosity of the elastomeric seal material 132, the microporous layers 120, 122 and PEM 124 tend to bend and break as shown in FIG. 1 as the elastomeric material 132 is molded onto and permeates the microporous layers 120, 122 while in the mold 155, thereby causing leaks in the structure. FIG. 2A shows an example traditional overmolded UEA 110 placed on a bipolar plate 116 while FIG. 2B shows an example traditional fuel cell assembly 112 having the traditional overmolded UEA 110 of and bipolar plates 114, 116. Accordingly, there is a need for a manufacturing method which provides a robust unitized electrode assembly and/or fuel cell assembly having a reduced risk of breakage and/or leaks in the gas diffusion layers.

### SUMMARY

The present disclosure provides for a stepped overmolded UEA for use in a fuel cell assembly. The stepped UEA includes a major diffusion layer, a minor diffusion layer, an overmolded subgasket, and a proton exchange membrane layer disposed between the major diffusion layer and the minor diffusion layer. The overmolded subgasket may be directly molded to the peripheral edge region for each of the major diffusion layer, the minor diffusion layer, and the proton exchange membrane layer.

In yet another aspect of the present disclosure a fuel cell assembly is provided which includes a first bipolar plate, a second bipolar plate, and a stepped UEA having an overmolded subgasket disposed between the first bipolar plate and the second bipolar plate. The stepped UEA further comprises a major diffusion layer, a minor diffusion layer, and a proton exchange membrane layer disposed between the major diffusion layer and the minor diffusion layer. It is understood that the minor diffusion layer has a surface area which is less than each of the major diffusion layer and the proton exchange membrane layer. The major diffusion layer and the proton exchange membrane layer may have surface areas which are substantially equivalent in size.

A process for manufacturing a stepped UEA includes the steps of providing a major diffusion layer, a PEM layer and a minor diffusion layer onto a lower supporting mold; enclosing the major diffusion layer, a PEM layer and a minor diffusion layer in the lower supporting mold and the upper mold; injecting a polymeric material into the mold; permeating the polymeric material into a peripheral edge area of each of the major and minor diffusion layers and molding the polymeric material directly onto the peripheral edge area of the PEM; and removing the overmolded UEA from the upper mold and lower supporting mold.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is a schematic, cross-sectional view of a traditional, overmolded UEA at a molding gate.

FIG. 2A is a schematic, cross-sectional view of the traditional, overmolded UEA on a second bipolar plate.

FIG. 2B is a schematic, cross-sectional view of the traditional, fuel cell assembly having an overmolded UEA disposed between a first bipolar plate and a second bipolar plate.

FIG. 3A is a schematic, cross-sectional view of an example non-limiting overmolded UEA on a second bipolar plate.

FIG. 3B is a schematic, cross-sectional view of an example, non-limiting fuel cell assembly having an overmolded UEA disposed between a first bipolar plate and a second bipolar plate

FIG. 4 a schematic, cross-sectional view of an example overmolded UEA disposed within at a molding gate in accordance with the present disclosure.

FIG. 5 is a flow chart which illustrates an example, non-limiting process for manufacturing the stepped UEA.

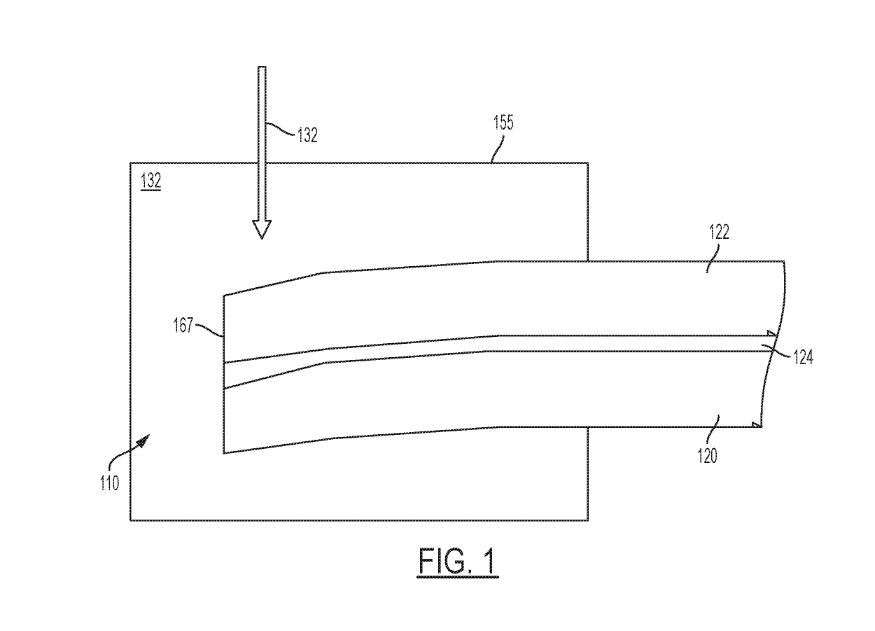

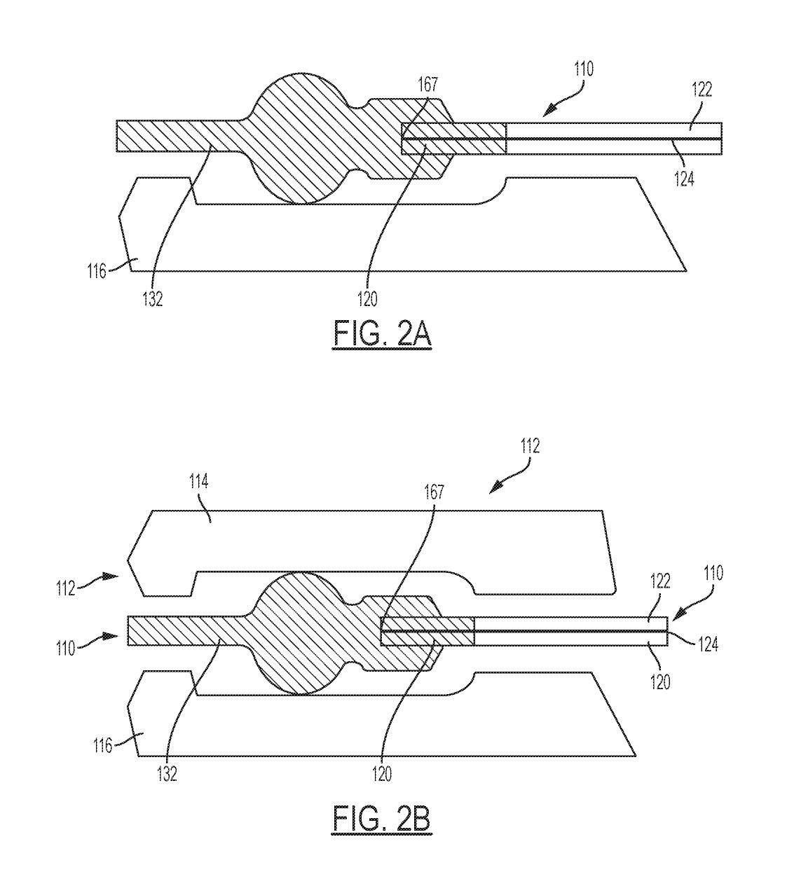

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

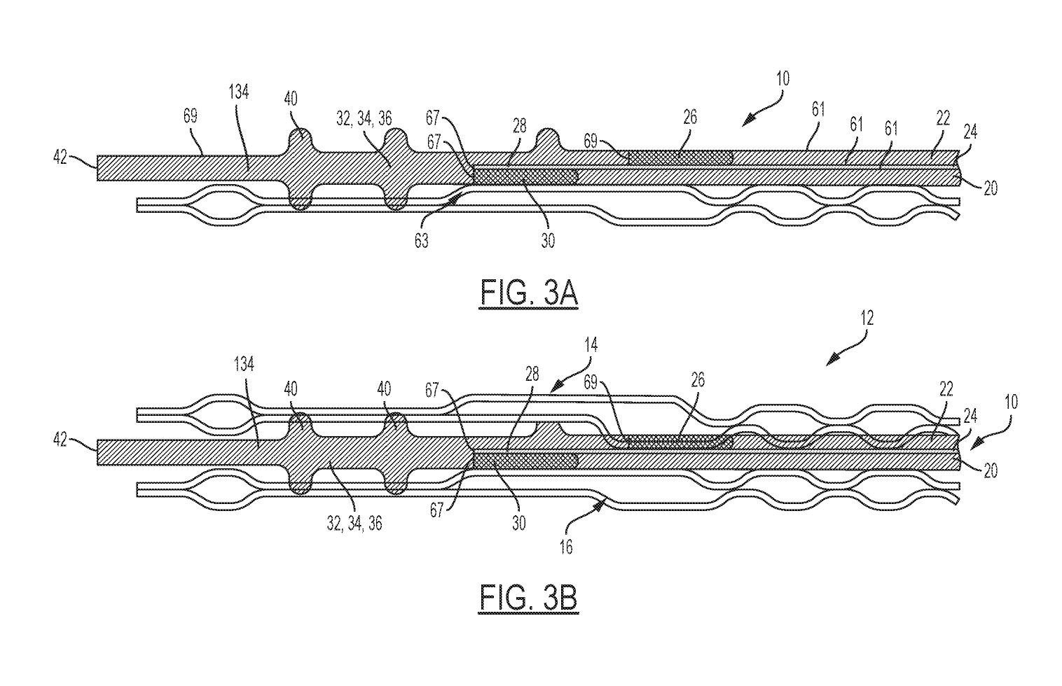

The present disclosure provides for a stepped overmolded UEA 10 for use in a fuel cell assembly 12. The stepped overmolded UEA 10 is shown in FIG. 3A. The stepped UEA 10 includes a major diffusion layer 20, a minor diffusion layer 22, an overmolded subgasket 34, and a proton exchange membrane layer 24 (PEM 24) disposed between the major diffusion layer 20 and the minor diffusion layer 22. The overmolded subgasket 34 may be directly molded to the peripheral edge region for each of the major diffusion layer 20, the minor diffusion layer 22, and the proton exchange membrane layer 24. The overmolded seal of the present disclosure prevents fluid transfer around the edge of the UEA 10 and effects fluid tight seals to both adjacent flow field plates due to a reduced risk of breakage in the microporous layers/PEM 24. As shown in FIG. 3A, the stepped UEA 10 arrangement is shown where the major diffusion layer 20 and the PEM 24 extend beyond the minor diffusion layer 22. As shown, the major diffusion layer 20, minor diffusion layer 22 and the PEM 24 each include a peripheral edge region shown as elements 26, 28, and 30 respectively in FIGS. 3A and 3B. The major diffusion layer 20 and the minor diffusion layer 22 may each be either an anode or a cathode. However, if the major diffusion layer 20 is an anode then then minor diffusion layer must be a cathode. Similarly, if the major diffusion layer 20 is a cathode, then the minor diffusion layer must be an anode.

It is understood that the stepped arrangement shown in FIGS. 3A-3B may be implemented along the entire periphery of the gas diffusion layers (major and minor) and the PEM 24. Therefore, it is understood that the proton exchange membrane layer 24 and the major diffusion layer 20 may be equivalently sized or have substantially equivalent surface areas while the surface area 61 of the minor diffusion layer 22 is smaller than that of the major diffusion layer 20. As shown in FIGS. 3A-3B, the end 69 of the minor diffusion layer 22 is disposed inboard of the ends 67 of the major diffusion layer 20 and PEM 24.

Under this arrangement, a peripheral edge region 28 of the proton exchange membrane layer 24 is exposed such that the polymeric material 32 of the subgasket may be molded directly onto the PEM 24. Moreover, in the molding process, the polymeric material 32 may be directly molded onto and permeate the peripheral edge region of the major diffusion layer 20 and the minor diffusion layer 22. The peripheral edge regions for the major diffusion layer and the minor diffusion layers are respectively shown as elements 30 and 26 where the cross hatching of the subgasket 34 and the various layers 20, 22 intersect. It is further understood that the polymeric material 32 may be directly molded to a peripheral edge region 28 of the proton exchange membrane layer 24 thereby forming the overmolded subgasket 34 for the UEA 10. The overmolded subgasket 34 is therefore configured to provide a barrier 36 between the major diffusion layer 20 and the minor diffusion layer 22 while also sealing the major diffusion layer 20 and the minor diffusion layer 22 from the external environment 38 as shown in FIG. 3B.

As shown in FIG. 3B, the overmolded subgasket 34 is configured to seal a first bipolar plate 14 to a second bipolar plate 16, and the overmolded subgasket 34 is further configured to seal the proton exchange membrane layer 24 and the major diffusion layer 20 to the second bipolar plate 16. It is further understood that the overmolded subgasket 34 may further define at least one sealing bead 40 proximate to an edge region of the overmolded subgasket 34. FIG. 3A and FIG. 3B show two sealing beads 40 which are disposed between the end 42 of the overmolded seal and the ends 67 of the major diffusion layer 20 and PEM 24. The sealing beads 40 may protrude out from the subgasket surface 69 as shown in FIG. 3A to enable the sealing between the first and second bipolar plates 14, 16 as shown in FIG. 3B.

In yet another aspect of the present disclosure a fuel cell assembly 12 is provided which includes a first bipolar plate 14, a second bipolar plate 16, and a stepped UEA 10 having an overmolded subgasket 34 disposed between the first bipolar plate 14 and the second bipolar plate 16. The fuel cell assembly 12 is shown in FIG. 3B. As shown, the fuel cell assembly 12 includes a stepped UEA 10 which further comprises a major diffusion layer 20, a minor diffusion layer 22, and a proton exchange membrane layer 24 disposed between the major diffusion layer 20 and the minor diffusion layer 22. It is understood that the minor diffusion layer 22 has a surface area 61 which is less than each surface 61 of the major diffusion layer 20 and the proton exchange membrane layer 24. The major diffusion layer 20 and the proton exchange membrane layer 24 may have surface areas 61 which are substantially equivalent in size.

As shown, a peripheral edge region 28 of the proton exchange membrane layer 24 is exposed such that the polymeric material 32 of the overmolded subgasket 34 may be directly molded onto the peripheral edge region 28 of the PEM 24. The stepped UEA 10 arrangement shown in FIG. 3B may be generally provided along the entire periphery 63 of the UEA 10. Therefore, it is understood that the proton exchange membrane layer 24 and the major diffusion layer 20 may be substantially equivalently sized having a substantially equivalent surface area 61. However, as shown, the minor diffusion layer 22 may have a surface area 61 which is smaller than the major diffusion layer 20 and the PEM 24. Under this fuel cell assembly 12 arrangement, the polymeric material 32 is molded to and permeates a peripheral edge region 30, 26 of the major diffusion layer 20 and the minor diffusion layer 22. It is further understood that the polymeric material 32 may be molded directly onto the peripheral edge region 28 of the proton exchange membrane layer 24 as shown in FIG. 3B.

Accordingly, the polymeric material 32 molded to the peripheral edge regions 30, 26, 28 of the major diffusion layer 20, the minor diffusion layer 22, and the proton exchange membrane layer 24 forms the overmolded subgasket 34 for the UEA 10. The overmolded subgasket 34 is configured to provide a barrier 36 between the major diffusion layer 20 and the minor diffusion layer 22 while also sealing the major diffusion layer 20 and the minor diffusion layer 22 from an external environment 38. As shown in FIG. 3B, it is further understood that the overmolded subgasket 34 is configured to seal the first bipolar plate 14 to the second bipolar plate 16, and the overmolded subgasket 34 is further configured to seal the proton exchange membrane layer 24 and the major diffusion layer 20 to the second bipolar plate 16. Moreover, as shown in FIG. 3B, the fuel cell assembly 12 further includes an overmolded subgasket 34 which defines at least one sealing bead 40 proximate to an edge region of the overmolded subgasket 34.

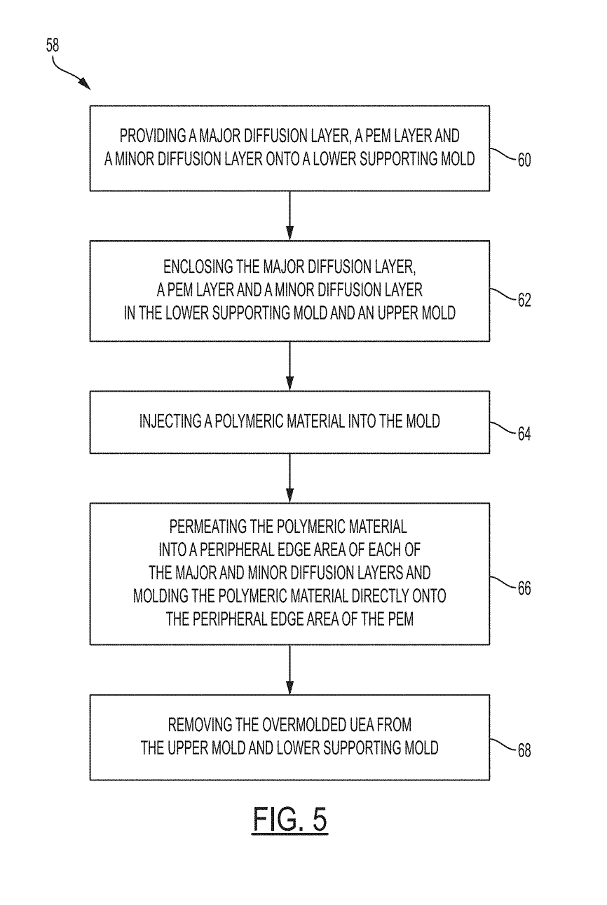

With reference to FIG. 5, the process 58 for manufacturing the overmolded subgasket 34 is shown in the form of a flow chart. The process 58 includes the steps of providing 60 a major diffusion layer 20, a PEM 24 layer and a minor diffusion layer 22 onto a lower supporting mold 50; enclosing 62 the major diffusion layer 20, a PEM 24 layer and a minor diffusion layer 22 in the lower supporting mold 50 and the upper mold 52; injecting a polymeric material 32 into the mold 55 (formed by the upper mold 52 and lower supporting mold 50); permeating 64 the polymeric material 32 into a peripheral edge region of each of the major and minor diffusion layers 20, 22 and molding 66 the polymeric material 32 directly onto the peripheral edge region 28 of the PEM 24 to create an overmolded UEA; and removing 68 the overmolded UEA 10 from the upper mold 52 and lower supporting mold 50. It is understood that the major diffusion layer, the PEM layer and the minor diffusion layer each include a peripheral edge region.

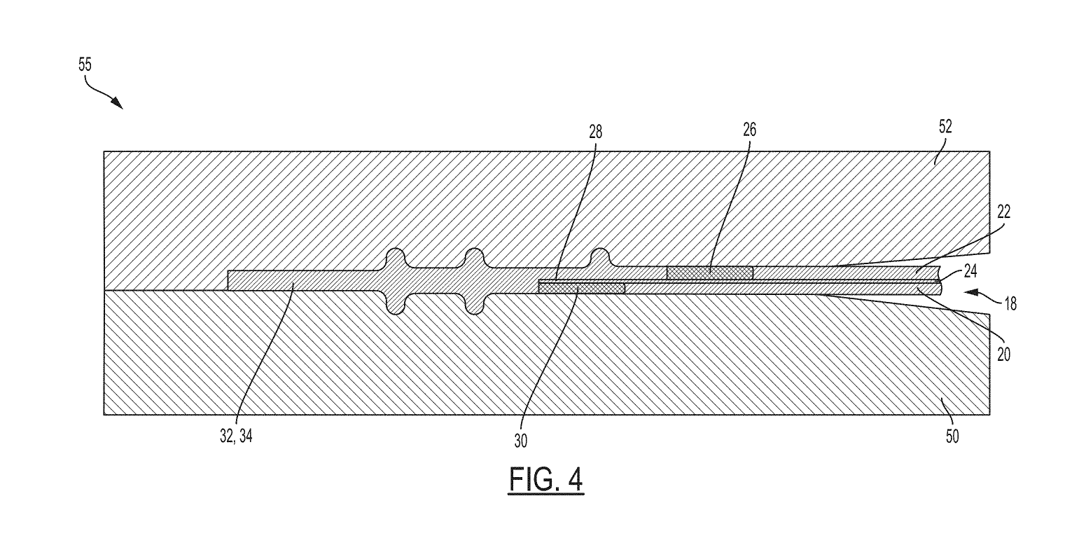

In the aforementioned process, it is understood that the minor diffusion layer 22 has a surface area 61 which is less than each surface layer 61 of the major diffusion layer 20 and the minor diffusion layer 22 which enables the peripheral edge region 28 of the PEM 24 to be exposed polymeric material 32. Moreover, it is understood that the lower supporting mold 50 supports the peripheral edge regions 30, 28 of the major diffusion layer 20 and the PEM 24 layer during the molding process thereby reducing the risk of breakage or leaks in the layers. The minor diffusion layer 22 as shown in FIG. 4 is supported by the PEM 24 and the major diffusion layer 20 thereby reducing the risk of any breakage or leaks in the minor diffusion layer 22 during the molding process.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method for manufacturing a stepped UEA comprising the steps of:
arranging a major diffusion layer, a minor diffusion layer and a PEM layer partially disposed between the major and minor diffusion layers such that the minor diffusion layer only spans the PEM layer outside of a PEM peripheral surface region thereby leaving the PEM peripheral surface region exposed;
providing the unitized electrode assembly onto a lower supporting mold;
enclosing the major diffusion layer, a PEM layer and a minor diffusion layer in the lower supporting mold and the upper mold, the major diffusion layer, the PEM layer and the minor diffusion layer each include a peripheral edge region;
injecting a polymeric material into the mold;
molding the polymeric material directly onto the PEM peripheral surface region to create an overmolded UEA; and
removing the overmolded UEA from the upper mold and lower supporting mold.

2. The method for manufacturing a stepped UEA as defined in claim 1 wherein the minor diffusion layer has a surface area which is less than each surface area of the major diffusion layer and the PEM thereby exposing the PEM peripheral surface region to the polymeric material being injected into the mold.

3. (canceled)

4. The method for manufacturing a stepped UEA as defined in claim 2 wherein the lower supporting mold supports a peripheral edge region of the major diffusion layer when the polymeric material is injected into the mold.

5. The method for manufacturing a stepped UEA as defined in claim 4 wherein the minor diffusion layer is supported by the PEM and the major diffusion layer when the polymeric material is injected into the mold.
